(19) United States
(12) Patent Application Publication
(10) Pub. No.: US 2026/0259708 A1
(43) Pub. Date: Sep. 3, 2026

(54) COMPOSITIONAL PROGRAM SYNTHESIS ENGINE IN AN ARTIFICIAL INTELLIGENCE SYSTEM

(71) Applicant: Microsoft Technology Licensing, LLC, Redmond, WA (US)

(72) Inventors: Ashish TIWARI, Sammamish, WA (US); Sumit Gulwani, Sammamish, WA (US); Vu Minh Le, Redmond, WA (US); Gust Ben Anneloes Verbruggen, Vlaams-Brabant (BE)

(21) Appl. No.: 19/067,689

(22) Filed: Feb. 28, 2025

(51) Int. Cl. G06F 8/35

(52) U.S. Cl. CPC G06F 8/35

(57) ABSTRACT

Methods, systems, and computer storage media for providing compositional program synthesis using a compositional program synthesis engine in an artificial intelligence (AI) system are described. Compositional program synthesis in this context is guided by a Large Language Model (LLL) and refers to the iterative process of using the LLM to generate, refine, and compose program segments, addressing errors by systematically breaking down tasks, salvaging correct parts, and synthesizing subprograms that are integrated using composition operators until a program satisfies the given specification. The compositional program synthesis engine iteratively generates, refines, and integrates program components by leveraging program decomposition, synthesis of subprograms, and composition operators to construct a program that meets the specified requirements. Compositional program synthesis engine supports several decomposition strategies associated with refining suffixes, refining prefixes, and IfThenElse distinct cases; and for synthesizing the new candidate programs the engine supports program composition operators including sequential composition and conditional composition.

### BACKGROUND

Users rely on Artificial Intelligence (AI) systems to efficiently retrieve and synthesize relevant information to generate insightful responses to their queries for informed decision making. Program synthesis is the process of automatically generating programs based on high-level specifications, input-output examples, or other forms of guidance. In program synthesis, AI, particularly machine learning models, can be used to automatically generate programs based on high-level specifications, examples, or natural language instructions. AI models, such as large language models (LLMs), can be trained to understand patterns in code and translate user intent into working code snippets. This process eliminates the need for manual coding by leveraging AI to automate the creation of programs. For example, given a set of input-output examples, an AI model could synthesize a Python function that transforms the input into the desired output. By learning from patterns in data, AI-based program synthesis tools can speed up development and enable non-experts to create complex programs without in-depth knowledge of coding.

### SUMMARY

Various aspects of the technology described herein are generally directed to systems, methods, and computer storage media for, among other things, providing compositional program synthesis using a compositional program synthesis engine in an artificial intelligence (AI) system. Compositional program synthesis in this context is guided by a Large Language Model (LLL) and refers to the iterative process of using the LLM to generate, refine, and compose program segments, addressing errors by systematically breaking down tasks, salvaging correct parts, and synthesizing subprograms that are integrated using composition operators until a program satisfies the given specification.

The compositional program synthesis engine iteratively generates, refines, and integrates program components by leveraging program decomposition, synthesis of subprograms, and composition operators to construct a program that meets the specified requirements. For example, given a task of extracting postal codes from addresses, an LLM generates an initial program that splits the address by commas but incorrectly includes extra text, like “IL 62704”. The compositional program synthesis engine extracts the correct prefix (splitting by commas), synthesizes a subprogram to isolate the postal code (e.g., removing the state), and combines these components using sequential composition. This iterative process repeats until the program outputs only the postal code, such as “62704”.

In operation, an original candidate program is generated based on an original specification. Original candidate program results are generated based on executing the original candidate program. Based on the original candidate program results, a determination is made that the original candidate program does not satisfy the original specification. Based on determining that the original candidate program does not satisfy the original specification, an extracted segment of the original candidate program is generated. Using a Large Language Model (LLM), a new subprogram based on the original specification and the extracted segment of the original candidate program is synthesized. Using the LLM, a new candidate program is synthesized based on combining the extracted segment of the original candidate program and the new subprogram with a program composition operation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A-1C are compositional program synthesis schematics associated with a compositional program synthesis workflow of a compositional program synthesis engine, in accordance with aspects of the technology described herein;

FIG. 2A is a block diagram of an exemplary AI system including a compositional program synthesis engine, in accordance with aspects of the technology described herein;

FIG. 2B is a flow diagram associated with an exemplary AI system including a compositional program synthesis engine, in accordance with aspects of the technology described herein;

FIG. 3 provides a first exemplary method of providing compositional program synthesis using a compositional program synthesis engine, in accordance with aspects of the technology described herein;

FIG. 4 provides a second exemplary method of providing compositional program synthesis using a compositional program synthesis engine, in accordance with aspects of the technology described herein;

FIG. 5 provides a third exemplary method of providing compositional program synthesis using a compositional program synthesis engine, in accordance with aspects of the technology described herein;

FIG. 6 provides a block diagram of an exemplary computing system suitable for use in implementing aspects of the technology described herein;

FIG. 7 provides a block diagram of an exemplary distributed computing environment suitable for use in implementing aspects of the technology described herein; and

FIG. 8 provides a block diagram of an exemplary computing environment suitable for use in implementing aspects of the technology described herein.

### DETAILED DESCRIPTION

### Overview

An artificial intelligence (AI) system is a platform designed to perform tasks that typically require human intelligence, such as understanding language, recognizing patterns, and making decisions, often through learning from data. Program synthesis is the process of automatically generating programs based on high-level specifications, input-output examples, or other forms of guidance. In program synthesis, AI, particularly machine learning models, can be used to automatically generate programs based on high-level specifications, examples, or natural language instructions. AI models, such as Large Language Models (LLMs), can be trained to understand patterns in code and translate user intent into working code snippets.

Program synthesis from input-output examples, also known as programming by example (PBE), has significantly advanced the automation of end-user tasks. However, it has largely depended on symbolic synthesis methods, which only scale effectively to small, domain-specific languages. While LLMs have the capacity to generate code in rich, general-purpose programming languages, LLMs models are highly sensitive to prompt variations, leading to unpredictable and unreliable outputs. For instance, minor changes in the phrasing of input specifications can cause significant errors, as LLMs often fail to fully comprehend or execute the given instructions.

Another challenge is the precision and reliability gap between symbolic synthesis techniques and LLMs. Symbolic methods excel in generating highly reliable programs by adhering to strict logical rules, but they are constrained to small, domain-specific languages (DSLs). In contrast, LLMs can operate in rich programming languages and address a broader range of problems but lack mechanisms to backtrack or repair errors when they occur.

The inefficiency of error recovery further complicates program synthesis with LLMs. Existing strategies like “self-reflection,” where an LLM revisits its initial output based on feedback, fail to effectively break down complex tasks into simpler subtasks. Consequently, errors persist, and reusable components of incorrect programs are often overlooked due to the token-based generation process typical of LLMs.

Finally, limitations in decomposition techniques hinder the full utilization of program semantics. Current methods often fail to extract meaningful subprograms or apply structured approaches to repair or rebuild incorrect outputs. As a result, the lack of well-defined semantics in subprogram generation reduces the success rate of solving complex tasks.

Consider a task where the user provides input-output examples to extract postal codes from a list of addresses: Input Examples: “123 Main St, Springfield, IL 62704” and “456 Elm St, Shelbyville, KY 40065”. Expected Output: “62704” and “40065”. An LLM might initially generate a program that splits the address string by commas but incorrectly includes extra text, like “IL 62704.” Conventional methods are unable to iteratively and efficiently refine the program until the program outputs only the postal code, such as “62704”. For example, they lack a methodology to salvage correct parts of the generated program (e.g., splitting strings by commas) and to resynthesize the erroneous components (e.g., extracting only the postal code). As such, program synthesis becomes unreliable: the synthesized programs do not meet the original specification associated with the input and output examples.

Conventionally, AI systems for program synthesis are not configured with a comprehensive computing logic and infrastructure provide advanced compositional program synthesis capabilities that support error recovery mechanisms, backtracking capabilities, and the ability to systematically decompose and reuse program components. LLMs can perform program synthesis from specifications expressed in natural language. However, LLMs are highly sensitive to prompt variations, making them prone to unexpected failures. This sensitivity undermines their reliability, especially when compared to symbolic techniques, which offer guarantees of correctness in synthesized programs. Nonetheless, symbolic techniques are limited to generating small programs within narrowly defined domain-specific languages, restricting their broader applicability relative to the versatility of LLMs.

Moreover, LLMs are not explicitly trained to perform “look-ahead” or “backtracking,” which are key capabilities of symbolic reasoning systems. Specifically, when generating the fifth line of code, an LLM does not revisit and modify the first line if errors or inconsistencies are detected. In contrast, symbolic reasoning engines typically leverage mechanisms that allow them to consider future outcomes and refine past decisions. To improve the robustness of LLM-based program synthesis, a backtracking capability can be employed—enabling the model to re-evaluate, revise, and correct previous decisions during the code generation process. As such, a more comprehensive AI system—with an alternative basis for performing program synthesis—can improve computing operations and interfaces for artificial intelligence systems.

### DESCRIPTION OF TECHNICAL SOLUTION

At a high level, the technical solution introduces an LLM-based program synthesis engine designed to iteratively refine programs that fail to meet their specifications. It begins with the LLM generating an initial program based on informal specifications, such as input-output examples or a high-level task description. When the generated program is incorrect, the LLM-based program synthesis engine extracts a segment of the program-such as a prefix, suffix, or the entire program—and uses the LLM to synthesize a new subprogram that addresses the errors. This new subprogram is then combined with the extracted segment using a program composition operator, such as sequential or conditional composition, to form a new candidate program. The process repeats until the program meets the desired specification.

This iterative methodology leverages the LLM's strengths while systematically addressing its shortcomings. By extracting correct parts of the program and focusing the synthesis on smaller subproblems, the LLM-based program synthesis engine improves reliability and reduces errors. For instance, prefixes and suffixes are often accurate because LLMs excel at handling input parsing and output construction, respectively. The LLM-based program synthesis engine also generates new specifications for subprograms by combining the original specification with the extracted segment, ensuring that refinements are contextually aligned with the task.

The framework can be applied effectively to Programming by Example (PBE), where specifications are provided as input-output examples. In the PBE context, input-output pairs are symbolically or dynamically transformed into new subproblem specifications, enabling precise and iterative synthesis. This structured process increases the likelihood of generating correct programs, contrasting with approaches like self-reflection by decomposing errors into manageable subtasks and leveraging composition operators to integrate solutions.

The technical solution provided uses a compositional program synthesis engine that is a Large Language Model (LLM)-guided compositional program synthesis engine that employs an iterative process designed to address failures in LLM-generated programs. The initial step utilizes an LLM to generate a program (e.g., an original candidate program) from the provided informal specification. If the original candidate program does not satisfy the informal specification, a segment of the program is extracted (e.g., extracted segment of original candidate program) and a new program (e.g., a new subprogram) is synthesized to integrate with the extracted segment, forming a new candidate program. The technique iteratively applies the following steps to refine incorrect programs into valid ones:

Operationally, at step 1: Extract a segment of the original candidate program. At step 2: Use an LLM to synthesize a new subprogram based on the original specification and the extracted segment of the original candidate program. At step 3: Combine the extracted segment of the original candidate program and the new subprogram using a program composition operator to form a new candidate program. These steps are repeated until a program meeting the specification is obtained.

For step 1, involving program segmentation of the original candidate program, three extraction strategies are employed for program segmentation via the program synthesis engine: (a) extract a prefix of the original candidate program, (b) extract a suffix of the original candidate program, or (c) retain the entire program. Prefix extraction leverages LLMs accuracy in processing input-related computations described by a specification. Similarly, suffix extraction leverages the LLM's ability to correctly construct outputs. Retaining the entire program is advantageous when minor adjustments are sufficient to correct the program.

For step 2, involving the synthesis of subprograms (e.g., a new subprogram) using the original specification and the extracted segment of the original candidate program, can be performed based on (a) generating a new specification for the new subprogram by combining the original specification and the extracted segment of the original candidate program using a composition operator, potentially using an LLM; and (b) synthesizing the new subprogram based on the new specification, potentially using an LLM.

For step 3, which involves program composition, standard composition operators are utilized, such as: Sequential composition: the output of one subprogram is used as the input to another; If-then-else composition: subprogram execution is conditional on a program state; and conditional sequential composition: The second subprogram's execution depends on conditions derived from the first subprogram's state.

This framework can be instantiated for “Programming by Example” (PBE), where the specification is provided as input-output examples. While Steps 1 and 3 remain unchanged, Step 2 is specialized: (a)—in the PBE context—generate, using a chosen composition operator, a new input-output specification for the new subprogram using the original input-output examples and the extracted segment of the original candidate program. This process can be performed symbolically or, where necessary, using an LLM.

Advantages of this approach include the ability to increase the likelihood of generating a correct program for an intended task. The approach introduces a structured recovery mechanism to iteratively resolve errors in LLM outputs, enabling unbounded error recovery layers. This approach contrasts with the “self-reflection” method, where LLMs reattempt the original task after identifying errors. In this approach, LLMs solve smaller, simplified subproblems in subsequent iterations, thereby improving the probability of success.

In this way, the compositional program synthesis engine is designed to generate programs that meet specific requirements, such as input-output examples or formal constraints. It operates by exploring the vast space of possible programs and identifying solutions that align with the given specifications. Through advanced computational techniques, including symbolic reasoning and the use of LLMs the compositional program synthesis engine streamlines the process of program creation.

The compositional program synthesis engine leverages the strengths of LLMs to guide the decomposition of complex tasks into manageable subtasks and solve these subtasks efficiently. This approach combines the token-by-token generation capabilities of LLMs, which are composed through string concatenation, with the ability to synthesize subprograms that are assembled using program composition operators. The incorporation of subprograms, which possess well-defined semantics, enable the compositional program synthesis engine to enhance its understanding of each component, ultimately improving the synthesis of other components.

At its core, the compositional program synthesis engine provides a mechanism that supports the capacity to revisit and repair program components based on the semantics of other elements. This iterative refinement process ensures that the generated programs are more reliable and robust. By integrating these capabilities, compositional program synthesis engine would offer a powerful tool for automating program creation while targeting rich and widely used programming languages, enabling developers to achieve higher efficiency and accuracy in solving programming-by-example tasks.

### Example Systems and Resources

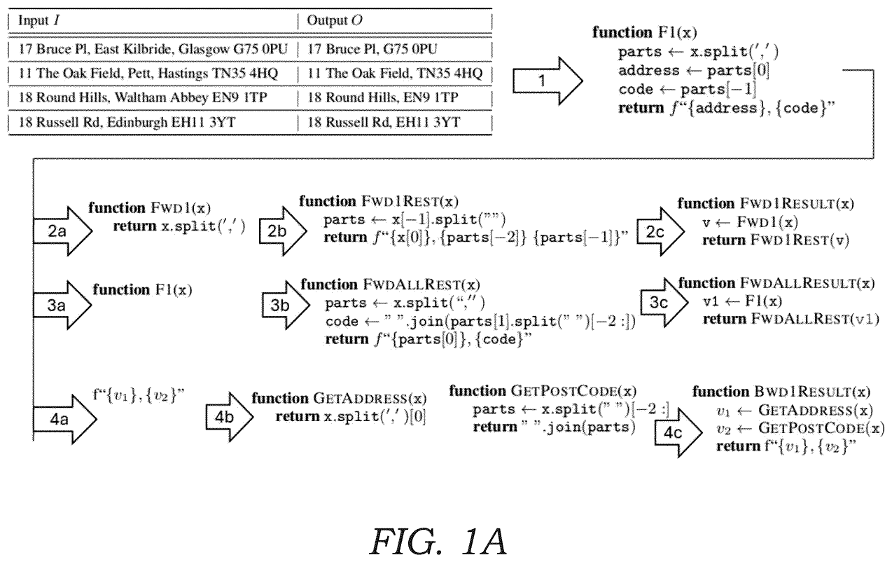

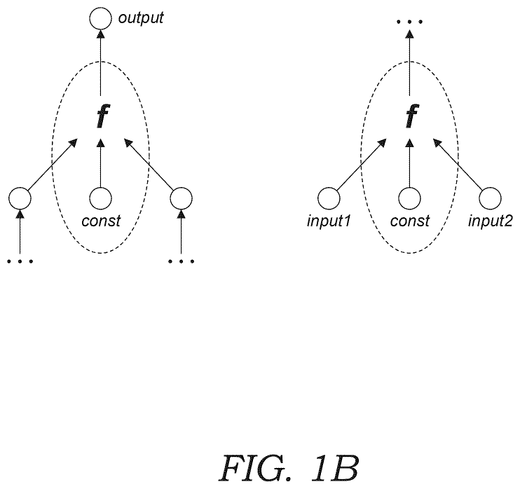

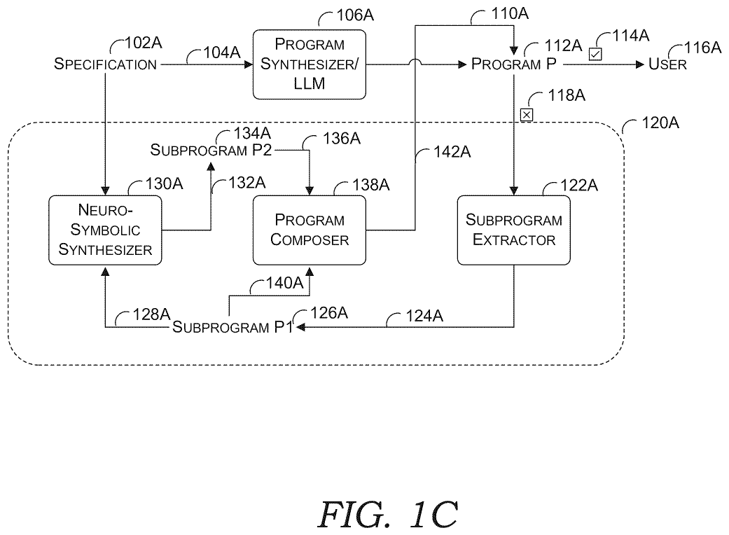

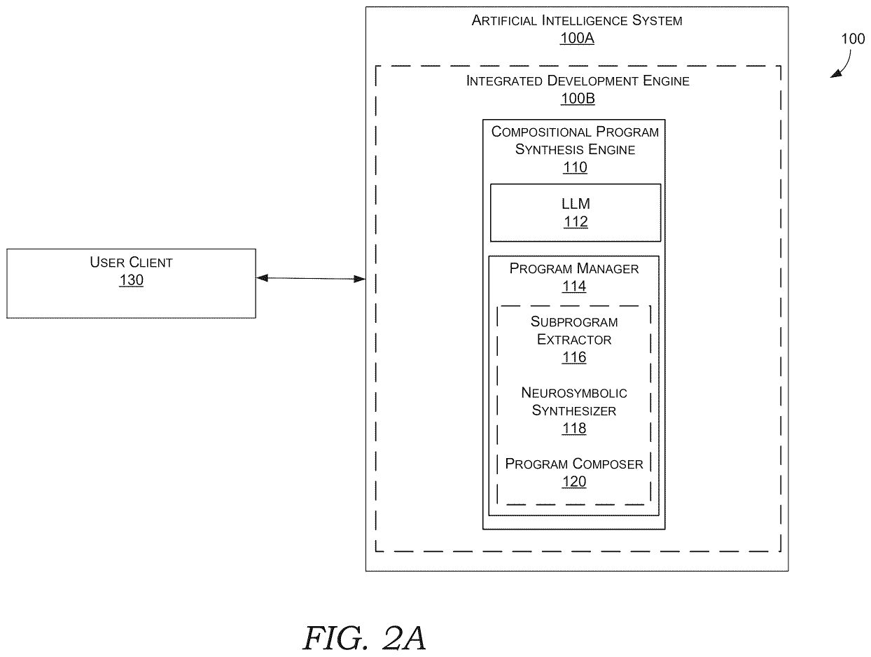

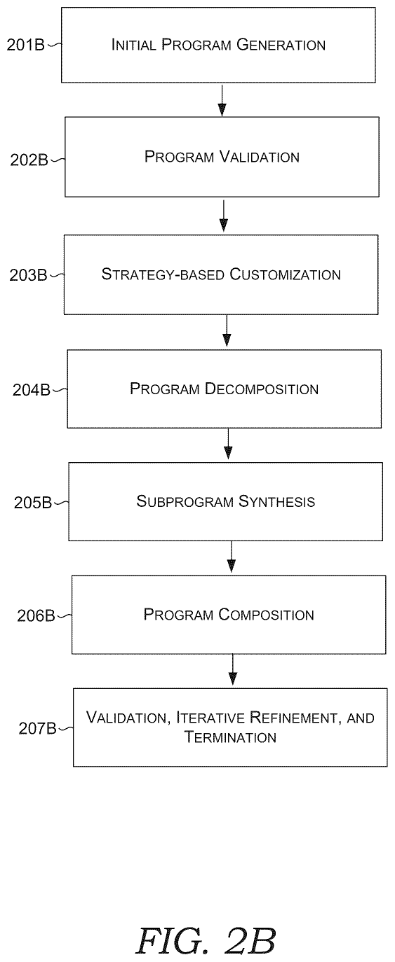

Aspects of the technical solution can be described by way of examples and with reference to FIGS. 1A, 1B, 1C, 2A and 2B. By way of context, the technical solution has been developed based on several important observations. The first observation is that even when large language models (LLMs) fail to generate a correct program, components of the failed program can often be reused. Programs generated from input-output examples frequently include a prefix, responsible for processing the input, or a suffix, responsible for producing the output, that is correct and salvageable. In some cases, the entire program is nearly correct and can be adjusted rather than discarded. Therefore, a systematic method is required for salvaging these components and constructing a correct program from them.

A second observation is that the prefix and suffix of a program align closely with the program expressions used in bottom-up and top-down synthesis, respectively. In bottom-up synthesis, a programming-by-example (PBE) task is addressed by starting with input values and generating new values through the application of functions from the target programming language. These functions, referred to as Forward1 programs, propagate the input values forward until the desired output value is produced. This process, termed forward synthesis, fixes the program's prefix and recursively addresses the subproblem of identifying the suffix that complements it. Conversely, in top-down synthesis, the process begins with the output value, and values that generate the output are identified through function applications, referred to as Backward1 programs. These values serve as new outputs, and the process continues until the input is reached. This approach, termed backward synthesis, fixes the program's suffix and recursively identifies the prefix that complements it.

By combining these observations, the likelihood that LLMs correctly generate the prefix and suffix of a program, even when the entire program is incorrect, is exploited. The prefix and suffix are connected to forward and backward synthesis, respectively, allowing Forward1 programs to be extracted from the prefix of an incorrect program and Backward1 programs to be extracted from its suffix. In this approach, incorrect programs generated by LLMs are parsed, with the cap of the parse tree corresponding to the suffix and serving as the Backward1 program, while the computations at the input leaves correspond to the prefix and serve as forward1 programs. Salvaged components are used to define new PBE subproblems, leveraging forward execution semantics for the Forward1 programs and inverse execution semantics for the backward1 program.

Additional strategies address common LLM failure modes. In cases where neither a proper prefix nor suffix can be salvaged, the entire incorrect program is retained, and a complementary piece is synthesized to correct it. These strategies, referred to as ForwardAll and IfThenElse, further enhance the approach.

An advantage of the technical solution lies in its ability to align the capabilities of LLMs with those of symbolic PBE solvers. While LLMs decompose program generation tasks into subtasks based on string concatenation, symbolic solvers guide decomposition through the abstract syntax tree (AST) of a program. Subproblems in symbolic solvers generate subprograms, which are composed using standard programming language operators rather than mere token concatenation. By enabling LLMs to compose outputs through programming language operators, the technical solution leverages the well-defined semantics of subprograms to guide LLMs more effectively. This approach, combining the ability to backtrack and repair components with the ability to compose subprograms, reduces error rates in program generation, as demonstrated through evaluation.

Consider the task of extracting the street name and postal code from an address, as shown in Table 1. The user provides a set of examples, consisting of input-output pairs (I, O). The user then asks a Large Language Model (LLM) to generate a program based on these input-output examples. In response, the LLM returns the function F1, as shown in Table 2. However, this program is incorrect because it also includes the city name in the output. The incorrect output generated by the program is shown in the Table 2, with the erroneous portion underlined.

The LLM-generated program in Table 2 contains reusable components. Often, the entire program is nearly correct and can be reused, or only parts of it—such as a prefix or suffix—are reusable. In this case, strategies can be applied to salvage these components and adapt them to create the correct program.

TABLE 1
Motivating task where given a column I of addresses, a user
wants to extract a new column of partial addresses show in O.

| Input I | Output O |
|---|---|
| 17 Bruce Pl, East Kilbride, Glasgow G75 0PU | 17 Bruce Pl, G75 0PU |
| 11 The Oak Field, Pett, Hastings TN35 4HQ | 11 The Oak Field, TN35 4HQ |
| 18 Round Hills, Waltham Abbey EN9 1TP | 18 Round Hills, EN9 1TP |
| 18 Russell Rd, Edinburgh EH11 3YT | 18 Russell Rd, EH11 3YT |

TABLE 2
Incorrect program F1 returned by LLM and the output O′ it generates.
The incorrectly included city name in O′ are underlined.

| | Program Output O′ := F1(I) |
|---|---|
| function F1(x): | 17 Bruce Pl, Glasgow G75 0PU |
| parts ← x.split(‘,’) | 11 The Oak Field, Hastings TN35 4HQ |
| address ← parts[0] | 18 Round Hills, Waltham Abbey EN9 1TP |
| code ← parts[−1] | 18 Russell Rd, Edinburgh EH11 3YT |
| return f“{address}, {code}” | |

It has been observed that the correct initial operations to be performed on the input are often identified by LLMs, even when fully correct code is not produced. This is possibly because the inputs I are accessible to the LLM, which assists in predicting the immediate operations to apply on I.

A Forward1 strategy can be employed, where the Forward1 strategy is based on this observation to correct the wrong program as follows: the first operation(s) performed on the input by the incorrect program are identified, the operations are executed on each of the inputs I in the IO examples to generate new values V, a new task of converting V to O is created, and the new problem is solved recursively.

In the running example, the first operation in the incorrect program F1 splits the input string by a comma and space, “,”, which is considered a reasonable first step. When this first step is executed on the inputs I, the intermediate values V obtained are lists of strings generated by applying split (“,”) to the inputs I. These values are shown in Table 3. A program is then generated by the LLM to convert V to the final output O. The function Fwd1Rest, which transforms V to O, is returned by the LLM. The complete program Fwd1Result for IO examples (I, O) can be obtained by composing the program Fwd1 for the IO examples (I, V) with the program Fwd1Rest for the IO examples (V, O), as shown in Table 3.

The intuition behind Forward1 is that execution results are provided to the LLM to assist in completing a task. The subproblem in the Forward1 strategy is created by using the outputs of the executions of the initial operations as new inputs. Thus, the LLM now has knowledge of the correct new program state and does not need to complete the program based solely on the original inputs and the partially-generated program. In fact, the original inputs and partially-generated program are forgotten, and the LLM is allowed to start fresh from the new program state. This feedback, in the form of execution results, helps the LLM to continuously correct its course, reducing the chances of mistakes being made

TABLE 3
Program Fwd1Final found by Forward1 strategy and the
intermediate values V used to create subproblem.

| | Output V of Fwd1(I) |
|---|---|
| function Fwd1(x): | 17 Bruce Pl, East Kilbride, Glasgow G75 0PU |
| return x.split(‘,’) | 11 The Oak Field, Pett, Hastings TN35 4HQ |
| function Fwd1Rest(x): | 18 Round Hills, Waltham Abbey EN9 1TP |
| parts ← x[−1].split(‘’) | 18 Russell Rd, Edinburgh EH11 3YT |
| return f“{x[0]}, {parts[−2]} {parts[−1]}” | |
| function Fwd1Result(x): | |
| v ← Fwd1(x) | |
| return Fwd1Rest(v) | |

Sometimes, almost correct programs are generated by the LLM, and only simple tweaks are needed to fix the output of the almost-correct program. Examples of this occur when the original LLM-generated program misses formatting the output correctly or generates an output with extraneous characters. In these cases, a second chance is given to the LLM to postprocess the output of the original wrong program, such as by applying the required trimming or formatting operations, through the ForwardAll strategy. In our running example, it is observed that extra characters are present in the output of the original incorrect program, and an attempt is made to see if a second LLM call can remove them.

In the running example, the ForwardAll strategy works by first executing the wrong program F1 (shown in Table 2) on the original inputs I. The execution of F1 is successful on all inputs I, and the outputs O′: =F1(I) are generated, as shown in Table 2. The ForwardAll strategy attempts to generate a correct program by producing a program that would transform the intermediate values O′ to the desired output O. The program returned by the LLM for the subtask of transforming O′ to O is shown in Table 4 as function FwdAllRest. The final correct program FwdAllResult is obtained by composing the wrong program F1 with FwdAllRest.

Intuition behind ForwardAll. In addition to the benefits of providing execution results, as mentioned above, it is noted that both Forward1 and ForwardAll create simpler subproblems for the LLM to solve. A common approach for improving the robustness of LLMs, especially for code generation, is to repeatedly invoke the LLM and ask it to fix its prediction by providing information related to mistakes in its prediction. This strategy is known as self-reflection. At first glance, the ForwardAll strategy may appear similar to self-reflection. However, a key difference is that in all our strategies, including ForwardAll, the LLM is tasked with solving new, simpler subtasks, and the original task is completely forgotten. In contrast, self-reflection maintains the original task and provides more information iteratively in a failure-guided manner.

TABLE 4
Program FwdAllFinal found by ForwardAll Strategy

| | |
|---|---|
| function FwdAllRest(x): | function FwdAllResult(x): |
| parts ← x.split(“,”) | v1 ← F1(x) |
| code ← “ ”.join(parts[1].split(“ ”)[−2:]) | return FwdAllRest(v1) |
| return f“{parts[0]}, {code}” | |

The third strategy for synthesizing a correct program from the given input-output examples is based on keeping the “suffix” of the incorrect program intact and adding a fixed “prefix” to it. The intuition behind the Backward1 strategy is that the last operations required for converting inputs/to outputs O are highly likely to be correctly predicted by LLMs. This is because the outputs O are available to the LLM, and it is often possible to predict the operation required to create O by analyzing its structure.

The Backward1 strategy works by (1) extracting the last operation used in the wrong program, (2) predicting the inputs, say I1 and I2, required by the last (binary) operation to generate the actual outputs O, and (3) creating two PBE subproblems—one to convert I to I1 and another to convert I to I2—and solving the two subproblems.

In the running example, the last operation used to compute the return value of the (incorrect) function F1 is a string concatenation operation, f“{address}, {postcode}”, which concatenates two strings stored in the variables address and postcode with a separator containing a comma and a space. The “inverse semantics” of this binary concatenation operation must then be applied to find the two inputs that would generate the outputs O. The LLM can be used to predict these values, which can then be verified using the usual operational semantics of the concatenation operator. These values are successfully predicted by the LLM for the running example, as shown in Table 5 on the left. This leads to two subproblems: converting the original inputs/to the street address and converting the original inputs I to the postcode. These two subproblems are simpler than the original problem. The LLM is asked to solve these two subproblems. If the LLM successfully solves the problems, for example by returning the functions GetAddress and GetPostCode shown in Table 5, the final correct program can be returned by executing these two programs (in parallel) and generating the final output by applying the concatenation operator from the wrong program.

The intuition behind Backward1 is that it shares the benefits of exploiting execution semantics and performing problem decomposition into simpler subproblems, as mentioned above. Specifically, it is noted that Backward1 can create multiple small subproblems. Additionally, the Backward1 strategy inherits the benefits of (symbolic) backward synthesis [13]. In contrast to forward synthesis, backward synthesis is goal-directed, and looking at the goal (output) helps limit the search space in symbolic backward synthesis, which potentially plays a role in the Backward1 strategy.

TABLE 5
The predicted inputs for the last step is shown on the left.
The two programs that generate those two inputs from the
original input are shown on the right, followed by the
final correct program obtained by Backward1 Strategy.

| Predicted Address | Predicted Postcode | |
|---|---|---|
| 17 Bruce Pl | G75 0PU | function GetAddress(x): |
| 11 The Oak Field | TN35 4HQ | return x.split(‘,’)[0] |
| 18 Round Hills | EN9 1TP | function GetPostCode(x): |
| 18 Russell Rd | EH11 3YT | parts = x.split(“ ”)[−2:] |
| | | return “ ”.join(parts) |
| | | function Bwd1Result(x): |
| | | v1, v2 = GetAddress(x), |
| | | GetPostCode(x) |
| | | return f“{v1}, {v2}” |

A final strategy for generating a correct program from an incorrect one is the IfThenElse strategy. In this approach, the incorrect program is used in one branch of an if-then-else structure, while the condition and the program for the other branch are synthesized. This strategy is applicable when the LLM generates a program that works correctly on some inputs but fails on others.

The IfThenElse strategy proceeds as follows: First, the LLM-generated program F1 is executed on all the inputs/to generate outputs O′. The input set I is then partitioned into two subsets: I1, which contains the inputs where F1 produces the correct outputs (i.e., F1 (i)=0), and I2, where the program fails. The next task is to synthesize a program, say F2, that works correctly on I2. If such a program F2 can be found, a condition c is generated that is true for inputs in I1 but false for those in I2. The final correct program is then obtained as “if (c(i)) then F1(i) else F2(i).” In practice, the intermediate values generated by F1(i), in addition to the inputs i themselves, are also used to help generate the required condition. Further details on condition generation will be discussed later.

For our running example, program F1 fails to work on all inputs in I, so the IfThenElse strategy is not directly applicable. However, consider a slightly modified version of the task, as shown in the first two columns of Table 1*, where city names are extracted from addresses.

TABLE 1*
The input-output examples for a task of extracting city names from
addresses and output of the incorrect program generated by the LLM.
The incorrect program is shown in the header of the third column.

| Input I | Output O | I.split(“, ”)[−2] |
|---|---|---|
| 17 Bruce Pl, East Kilbride, Glasgow G75 0PU | East Kilbride | East Kilbride |
| 11 The Oak Field, Pett, Hastings TN35 4HQ | Pett | Pett |
| 18 Round Hills, Waltham Abbey EN9 1TP | Waltham Abbey | 18 Round Hills |
| 18 Russell Rd, Edinburgh EH11 3YT | Edinburgh | 18 Russell Rd |
| 49 Kent Dr, Redwood City, CA 94025 | Redwood City | Redwood City |
| 1229 237th Pl NE, Kirkland, WA 98075 | Kirkland | Kirkland |

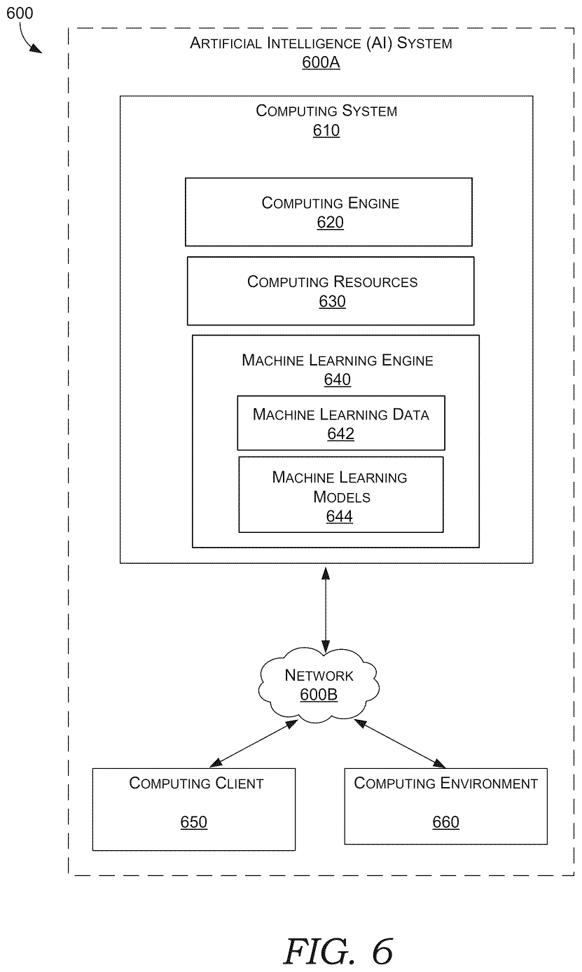

Two additional U.S. addresses, which have a different format compared to the first four, were added to the input set I. The LLM generates program F1 (shown in FIG. 6) that returns x.split(“,”)[−2], and the output of this program is shown in the third column of Table 1. It is evident that the LLM primarily focuses on the first and last addresses, producing a program that works for those, but fails on the middle two inputs. This is a common occurrence: when the uncommon case is not at the end of the list of IO examples, LLMs tend to give less attention to them and generate programs that do not handle those cases properly.

TABLE 6
The programs F1 and F2 that work on different inputs, but together cover
all inputs, and the final program F3 obtained by using one or the other
depending on a condition (on an intermediate value created in F1).

| | |
|---|---|
| function F1(x) | function F3(x) |
| parts ← x.split(‘, ‘) | parts ← x.split(‘, ‘) ν1 ← |
| return parts[−2] | parts[−2] |
| | if len(parts)==2 then |
| function F2(x) | return ν1 |
| r ← r′,\s*([\hat{ },]+)\s+[A-Z]{1,2}\d{1,2}\s+\d[A-Z]{2}′ | return F2(x) |
| match ← re.search(r, x) | |
| return match.group(1).strip( ) | |

Since program F1 fails on the 3rd and 4th inputs, a second LLM call is made to find a program that works for these two inputs. The LLM returns program F2 (shown in FIG. 6). The next step is to generate a condition to decide which program to apply to any given input. The LLM is asked to generate this condition, but rather than just focusing on the inputs, the program state reached after executing F1( ) on the input is presented to the LLM. This allows the LLM to use intermediate variables, such as parts, when generating the condition. The final program is constructed by combining the condition with programs F1 and F2, resulting in program F3 (shown in Table 6). It is assumed that executing F1 on all inputs leads to a program state. If certain inputs throw exceptions, the condition can only be generated using the input values unless F1 throws an exception on all inputs in one of the sets. In that case, F1 and F2 can be combined using a try-catch block.

The intuition behind the IfThenElse strategy comes from the observation that LLMs tend to ignore certain input-output examples when presented with a set. Typically, the IO examples in the middle of the list have less influence on the LLM's generation compared to those at the start or end of the list. This results in the LLM generating programs that work for some inputs but fail for others. The strategies allow the LLM to “backtrack” and revisit parts of the program, such as adding a conditional branch. This approach is not possible in the traditional linear generation of code, where the LLM processes the program from left to right or top to bottom.

With reference to FIG. 1A, consider the task of extracting the street name and postal code (in column O) from an address (in column I). The user has provided a few examples, consisting of inputs in column I and corresponding outputs in column O. In Step (1), we ask an LLM to synthesize a program that transforms input I into output O. The LLM returns the function F1 shown in FIG. 1. However, this program is incorrect as it includes the city name in the output as well. To address this, we explore a few decomposition strategies.

In Strategy Forward1, steps (2a), (2b), and (2c) are employed. In Step (2a), the first operation in the incorrect program F1 (splitting the input string by a comma and space, “,”) is preserved as FWD1. In Step (2b), FWD1 is executed on the inputs I to generate intermediate values V, and then the LLM is asked to generate a program that transforms V into the final output O. The LLM returns FWD1REST. In Step (2c), these pieces are combined to create the final program, FWD1RESULT.

In Strategy ForwardAll, steps (3a), (3b), and (3c) are employed. In Step (3a), the entire incorrect program F1 is preserved. In Step (3b), F1 is executed on the inputs I to generate intermediate values V, and ask the LLM to generate a program that transforms V into the final output O. The LLM returns FWDALLREST. In Step (3c), the pieces are combined to create the final program, FWDALLRESULT.

In Strategy Backward1, steps (4a), (4b), and (4c) are employed. In Step (4a), the last line of the incorrect program, which generates the output by joining two inputs with a comma, is preserved. In Step (4b), the LLM is used to reverse-execute the last line on the outputs O to generate plausible values for v1 and v2, then LLM is asked to generate two programs that convert I to the values v1 and v2, respectively. The LLM returns GETADDRESS and GETPOSTCODE. In Step (4c), these pieces are combined to create the final program, BWDIRESULT.

A fourth strategy, IfThenElse, is employed if the original program F1 works correctly on some inputs but not others. This is not the case for our example here, but it is a valid strategy when the previous ones do not work. Any one of the four strategies, when successful, would allow a declaration of success for the task.

As shown in FIG. 1A, Input-output (IO) examples are started with. In Step (1), a program F1 is generated using an LLM. Since the desired outputs are not generated by F1, (2a) it is decomposed and FWD1 is salvaged, (2b) the remaining task of transforming the output of FWD1 to O is solved using LLM, and if successful, (2c) the composed program is returned. If unsuccessful, (3a) the full F1 is salvaged, (3b) LLM is used to transform the output of F1 to O, and if successful, (3c) the composed program is returned. If unsuccessful, (4a) the last step is salvaged, (4b) LLM is used to synthesize the two pieces needed to produce the two variables used in the last step, and (4c) the composed program is returned. A fourth if-then-else composition-based strategy is also included in the approach.

The problem of programming-by-example is now defined. Let Values be the universal set of (concrete) values, which includes strings, numbers, lists, and tuples. A value in Values is denoted by v, but it may be annotated to indicate if it is an input value, vᵢₙ, or an output value, vₒᵤₜ. Let Prgms be the set of programs in a programming language. The semantics of a program is a function that maps (input) values to (output) values. No differentiation is made between the syntax F of a program and its semantics, so F is used to denote a program, and F(v) denotes the output of the program F when it is applied to the input value v E Values. Since values can be tuples, multiple inputs (as a tuple) can be taken by our programs and multiple outputs (as a tuple) can be produced. Since no differentiation is made between syntax and semantics, v is also used as a program variable.

An IO example, or simply an example, ex is a pair (vᵢₙ, vₒᵤₜ) consisting of an input value vᵢₙ and an output value vₒᵤₜ. A PBE task is a set Ex of examples. A solution of the synthesis task Ex in the target language Prgms is a program F∈Prgms such that F(vᵢₙ)=vₒᵤₜ for every example (vᵢₙ, vₒᵤₜ)∈Ex. If program F solves the PBE task Ex, it is denoted as F|=Ex. The notation F/|=Ex denotes the negation of F|=Ex.

Example 1. Consider the motivating scenario shown in FIG. 1. Here, the PBE task Ex contains 4 examples. The input values are strings, and the output values are strings. In the first example (vᵢₙ₁, vₒᵤₜ₁), the input vᵢₙ₁ is “17 Bruce Pl, East Kilbride, Glasgow G75 0PU” and the output value vout1 is the string “17 Bruce Pl, G75 0PU.” The Python program F1 in FIG. 1A is not a solution for this PBE task, but the Python program FWD1RESULT in the same figure is a (correct) solution.

It is assumed that the set Prgms of programs in the language PL is closed under the usual composition operators, such as sequential composition, which was used to combine small programs into a large program in Steps (2c), (3c), and (4c) in FIG. 1, and the if-then-else operator.

The problem of program synthesis through failure-guided compositional strategies is presented in this section. The task of synthesizing a program consistent with a given set of input-output examples is considered.

The SYMLLM approach solves this problem as follows:

An LLM with an appropriate prompt is used to generate a candidate program F in Prgms.

F is executed on the input values in Ex to check if F|=Ex.

If F|=Ex, F is returned.

The subset Ex₁ of examples on which F works correctly is computed, i.e., Ex₁={(v_{in i}, v_{out i})∈Ex|F(v_{in i})=v_{out i}}.

Given Ex, F, and Ex₁, one of the following four strategies is then used to complete the task.

In the IfThenElse strategy:

If Ex1 is not empty, Ex₂=Ex\Ex₁ is computed, and the PBE task Ex₂ is recursively solved to find F₂ such that F₂|=Ex₂.

If F₂ is found successfully, an LLM is used to synthesize the condition c such that c(vin) is true for all (v_{in,})∈Ex₁ and c(vᵢₙ) is false for all (v_{in,})∈Ex₂.

If a valid condition c is found, the program is returned:

```
function ITE(v)
  if c(v) is true then
    return F(v)
  else
    return F2(v)
```

The ForwardAll strategy:

New IO examples are constructed using the value computed by F as the input and the original outputs as the desired outputs, i.e., Ex′={(v′ᵢ, vₒᵤₜᵢ)|(vᵢₙᵢ, vₒᵤₜᵢ)∈Ex, v′ᵢ=F(vᵢₙᵢ)}.

The PBE task Ex′ is recursively solved to find F′ such that F′|=Ex′.

If F′ is found successfully, the program is returned:
function FORWARDALLRESULT (v)
   v′←F(v)
   return F′(v′)

The Forward1 strategy:

A prefix program F₁ is extracted from the program F, and a new set of examples Ex′={(v′ᵢ, vₒᵤₜᵢ)|(vᵢₙᵢ, vₒᵤₜᵢ)∈Ex, v′ᵢ=F1 (vᵢₙ)} is constructed.

The PBE task Ex′ is recursively solved to find F′ such that F′ |=Ex′.

If F′ is found successfully, the program is returned:
function FORWARD1RESULT(v)
   v′←F1(v)
   return F′(v′)

The Backward1 strategy:

A suffix F2 is extracted from the program F, using some set of values computed by the prefix of F. Let vₐ and v_{b} be the two values used by F₂.

Two new sets of examples, Exₐ and Ex_{b}, are created as follows: for every (vᵢₙᵢ, vₒᵤₜᵢ)∈Ex, if vₒᵤₜᵢ=F2((vₐ, v_{b})), then (vᵢₙᵢ, vₐ) is added to Exₐ, and (vᵢₙᵢ, v_{b}) is added to Ex_{b}.

The PBE tasks Exa and Exb are recursively solved to find Fₐ and F_{b} such that Fₐ|=Exₐ and F_{b}|=Ex_{b}.

If Fₐ and F_{b} are found successfully, the program is returned:
function FORWARDALLRESULT(v)
   v′←F(v)
   return F′(v′
function BACKWARD1RESULT(v)
   va←Fa(v)
   vb←Fb(v)
   return F2((va, vb))

The process of creating Exₐ and Ex_{b} requires executing the “inverse” semantics of F2. An LLM is used to perform this step, and the forward execution of F2 is used to verify the prediction of the LLM.

It is clear that the approach is sound: if a program F is returned for a given PBE task Ex, then F will satisfy the given examples, that is, F|=Ex. The approach is recursive, and in experiments, the recursion depth is restricted to 1 for efficiency. For the approach to succeed, the following conditions must be met:
(1a) Either the prefix or suffix of the wrong program must be the prefix or suffix of some correct program, or (1b) the wrong program must be one of the branches of a correct conditional program.
(2) The subproblems must be successfully created.
(3) The LLM must successfully solve the subproblems.

Turning to FIG. 1B, a key step in our approach is the decomposition of a (wrong) program into two parts, which have been informally called the prefix and suffix of the program. The details of this decomposition and the extraction of the forward1 program and the backward1 program are described here.

Prefix and suffix are extracted for the purpose of decomposition through the control flow graph of the program. Consider a program F that computes output o from the inputs, say vᵢₙ₁ and vᵢₙ₂. As shown in FIG. 1B, a tree is built whose leaves are the inputs (and all constants) at the bottom (shown on the right), and whose root is the output at the top (shown on the left). Every node in this tree is either a value node or a function node. A function node, annotated with f, takes the values of all its children (below) and applies f on those values to get a result that becomes the value of its parent.

In Forward1 decomposition, the “prefix” extracted from F, say F₁, consists of the first step performed on the inputs in the computational tree. As shown on the right of FIG. 2, f(x₁, C, x₂) is (one of) the first computation performed on (some subset of) the inputs, x₁ and x₂, where c is a constant. Hence, a possible forward1 program, F₁, is λx₁, x₂: f(x₁, C, x₂). In the Forward1 strategy, the program F₁ is fixed as the first step, and the rest of the program is synthesized recursively. The input-output examples for the rest of the program are easily obtained by executing F₁ on the inputs from the IO examples Ex.

In Backward1 decomposition, the “suffix” extracted from F, say F₂, consists of the last step that generates the output in the computational tree. As shown on the left of FIG. 2, f(x₁, c, x₂) is the last computation performed because its result is the output vₒᵤₜ. Hence, a possible backward1 program, F₂, is λx1, x₂: f(x1, c, x₂). In the Backward1 strategy, the program F₂ is fixed as the last step, and the remaining program is synthesized recursively. Two subprograms are synthesized—one that computes x₁ and another that computes x₂. It is challenging to find the input-output examples for the two subprograms. Back propagating the output values through F₂ is required to find the values v₁ and v₂ such that f(v₁, c, v₂)=vₒᵤₜ. Note that there could be multiple such v₁, v₂ that all produce the same output vₒᵤₜ. Ideally, the values v₁ and v₂ that are most likely to be generated from the input vin should be picked. A large language model (LLM) is used to generate the candidate values v₁, v₂, and then the pair that actually generates v is picked by executing f on the candidate inputs. The LLM prompt for back propagation is shown in Table 7. The prompt is designed to be used with the chat completion API of LLMs and contains a system message that describes the task and a couple of “few-shot” examples that illustrate the task. Multiple responses are generated at a temperature of 0.4.

In the IfThenElse strategy, the challenging step is the generation of the condition c. Recall that the condition learning problem is as follows: given a program F₁ that works on examples Ex₁ and a program F₂ that works on examples Ex₂, a condition c must be found that can be used to decide whether to route the input to F₁ or F₂. LLM is again used to generate the condition. The prompt for condition learning is shown in Table 8. The prompt instructs the model to generate a Python function. Emphasis is placed on learning generalized predicates since the LLM has a tendency to overfit the conditions to the values provided in Class1 and Class2. The word “sample” helps the model realize that the values provided in the classes are only samples, and so it should generate conditions based on the common patterns seen across the samples. Any Boolean-valued Python program returned by the model can be checked for correctness by executing it on the elements in Class1 and Class2.

Four synthesis strategies were described: FORWARDALL, FORWARD1, BACKWARD1, and IFTHENELSE. However, the selection of which one to use and the order in which to try them was left unspecified.

The generic precondition that guards the application of the FORWARD1, FORWARDALL, and BACKWARD1 strategies is that a program F should exist that is not a solution for Ex. Additionally, for FORWARD1, a nonempty set of forward1 programs, Prgms1, should be extracted from F, and these programs should generate non-⊥ values when executed on the inputs in the examples Ex. If these checks are violated, FORWARD1 is not applicable. Analogous preconditions can be easily written for the BACKWARD1 strategy and the FORWARDALL strategy. The strategies are evaluated whenever they are applicable, and the trigger conditions for the strategies are not the focus of this paper.

system: You are an expert Python programmer. You are given a Python expression and some output values it computes. For every output value, your task is to provide the inputs on which the expression evaluates to that output value. For each output value, as a help, you are also given some additional values that can be used as inspiration for predicting the inputs.

TABLE 7
Prompt for back propagating values through backward1 functions. The
prompt consists of a system prompt, followed by two examples showing
what the user might say and how the assistant is supposed to reply.
The last message from the user is instantiated to the actual values.

user: {’expr’: ’new_var.split(″:″)[θ]’, ’outputs’: [{’output’: ’foo’,
’additional values’: [’1234,foo:bar’]}, {’output’: ’show’, ’additional values’:
[’4356,show:full’]}]}
assistant: [{’output’: ’foo’, ’inputs’: ’new_var = ″foo:bar″’}, {’output’: ’show’,
’inputs’: ’new_var = ″show:full″’}]
user: {’expr’: ’f″{new_ var0 {new_var1}″’, ’outputs’: [{’output’: ’bar baz’,
’additional values’: [’try, baz, bar, me’]}, {’output’: ’joe smith’, ’additional values’:
[’done, smith, joe, cse’]}]}
assistant: [{’output’: ’bar baz’, ’inputs’: ’new_var0 = ″bar″\n new_var1 = ″baz″’},
{’output’: ’joe smith’, ’inputs’: ’new_ var0 = ″joe″\n new_var1 = ″smith″’}]
user: {’expr’: [symbol] f(new_var0, c, new_var1) [symbol] , ’outputs’: [{’output’: [symbol]
ν₁ [symbol] , ’additional values’: [symbol] st₁ [symbol] }, {’output’: [symbol] ν′₁ [symbol] , ’additional values’: [symbol] st′₁ [symbol] }]}

TABLE 8
Prompt for generating conditions to be used in if-then-else
programs, facilitating the parallel composition of two programs
to produce a correct final program. Any candidate programs
generated can be executed to verify their correctness.

user: class1 sample states = [{...},
{...},...]
user: class2 sample states = [{...},
{...},...]

With reference to FIG. 1C, FIG. 1C illustrates a workflow associated with the compositional program synthesis engine that provides a structured approach to refining programs that fail to meet the given specification.

Operationally, the process begins with a specification 102A, which defines the requirements for the desired program. This specification 102A can include input-output examples, high-level task descriptions, or both. Program Synthesizer/LLM 106A receive 104A specification 102A and generates 110A an initial Program P 112A based on the specification 102A.

The generated Program P 112A is executed and validated against the specification. If it satisfies 114A the specification, it is returned to the User 116A as the final output. If Program P 112A does not satisfy 118A the specification 102A, it enters 114A a feedback loop for refinement 120A.

The Subprogram Extractor 122A analyzes Program P 112A and identifies 124A reusable components, such as correct prefixes, suffixes, other subsegments, or the entire program. These extracted components are labeled as Subprogram P1 126A, representing the part of the program that can be salvaged for reuse.

Subprogram P1 126A is communicated 128A to Neuro-Symbolic Synthesizer 130A that uses the Subprogram P1 126A synthesize 132A a subprogram (P2) 134A that addresses the errors or gaps identified in the original program. The synthesis process may involve leveraging symbolic methods, LLMs, or both, ensuring that the new subprogram aligns with the original specification. Subprogram P2 is communicated 136A to Program Composer 138A. Subprogram P1 126A is communicated 140A to Program Composer 138A.

The Program Composer 138A combines the extracted Subprogram P1 with the newly synthesized Subprogram P2 using program composition operations in a new candidate program. These operations include sequential composition: combining components in a linear flow; conditional composition: introducing conditional logic to handle edge cases or input variability; and If-then-else composition: branching logic based on specific input properties.

The new candidate program is communicated 142A for revalidation. If the new candidate program still does not satisfy the specification, it re-enters the loop for further decomposition, subprogram synthesis, and composition. This iterative process continues until the program meets the specification or a termination condition is reached. Once a new candidate program satisfies the specification, it is returned as the final output to the User.

This illustrates the iterative process for compositional program synthesis, where failures in the initial program led to targeted refinements. The integration of extraction, synthesis, and composition ensures that the technical solution adapts dynamically to failures and efficiently converges on a program that meets the user's specification.

With reference to FIG. 2A, FIG. 2A, illustrates a cloud computing system 100, artificial intelligence (AI) system 100A, integrated development engine 100B, compositional program synthesis engine 110, LLM 112, program manager 114 and user client 130.

The technical solution (i.e., LLM-based compositional program synthesis) can operate cloud-based system designed to automate and refine program synthesis tasks. At its core, the cloud computing system 100 integrates several key components to collaborate in generating, validating, refining, and finalizing programs that meet user-defined specifications. These components work together in an iterative process to address failures and progressively improve the generated programs until they meet the original specification.

The integrated development engine 100B serves as the central hub for managing program synthesis. Integrated development engine 100B orchestrates the interaction of various subsystems, beginning with the program synthesis engine 110, which utilizes a Large Language Model (LLM) 112 to generate an original candidate program. The original candidate program is derived from an original specification, which may include input-output examples, high-level task descriptions, or both. When both are provided, the program synthesis engine 110 may dynamically resolve ambiguities by analyzing relationships between the examples and the description. For instance, in a task to extract street names and postal codes from addresses, input-output examples may map “123 Main St, Springfield, IL 62704” to “123 Main St, 62704”, while the task description clarifies that city names and other details must be excluded. The LLM synthesizes an executable candidate program based on this guidance, forming the foundation for further refinements.

Once the original candidate program is generated, it is executed to produce original candidate program results. These results are evaluated using and validated. Program synthesis engine 110 also analyzes variability in input formats and identifies failure modes that the program exhibits. For example, a candidate program might successfully process simple addresses but fail when handling additional fields like “Suite 200”, highlighting its inability to accommodate variable-length input segments. Errors are categorized into syntax errors, such as invalid or incomplete code; logical errors, where the program's operations fail to align with the specification; and structural errors, where the organization of the program's components is flawed.

Validation can determine that the candidate program does not satisfy the original specification. Determining that the original candidate program does not satisfy the original specification can further include analyzing variability in input formats and identifying failure modes based on input-specific characteristics. Input-specific characteristics refer to the unique properties or patterns within the input data that impact how the program processes it. These include structural variations, such as optional fields like “Suite 200” or “Apt 3B”, which may or may not appear in certain inputs. They also encompass content-specific differences, such as zip codes being represented in standard formats (e.g., “62704”) or extended formats (e.g., “62704-1234”). Additionally, variability in delimiters (e.g., commas, spaces, or semicolons) can affect how inputs are parsed. By analyzing these characteristics, the system identifies failure modes where the program's logic does not account for these variations, guiding targeted refinements.

Program manager 114 orchestrates processes involving three core components: a subprogram extractor 116, a neurosymbolic synthesizer 118, and a program composer 120. The subprogram extractor 116 is responsible for identifying and isolating meaningful subprograms from input data or existing programs. This process involves analyzing the structure, context, and relationships within the code to extract reusable functional elements. These subprograms are then passed to the neurosymbolic synthesizer, which blends neural network-based reasoning with symbolic logic to refine, optimize, or even generate entirely new subprograms. The neurosymbolic synthesizer 118 ensures that the resulting programs are both efficient and contextually aligned with the desired functionality. Finally, the program composer 120 takes the outputs from the synthesizer and integrates them into a coherent, executable program. It ensures that the components work seamlessly together, resolving dependencies and maintaining the overall structural integrity of the program. Together, these components enable the program manager to create, refine, and assemble complex programs with high precision and adaptability.

Operationally, program manager 114 takes over to decompose the original candidate program into smaller, reusable components. These components may include a prefix, which typically handles input parsing; a suffix, responsible for output construction; or the entire program, when most of it is correct but minor adjustments are needed. The manager dynamically selects a decomposition strategy based on the type of failure identified. For instance, a Forward1 strategy is applied when the prefix is correct and the suffix requires resynthesis, while a Backward1 strategy retains a correct suffix and refines the prefix. If distinct cases in the input require conditional handling, an IfThenElse strategy introduces branching logic. The manager also evaluates the interchangeability of prefix and suffix segments, maximizing the utility of reusable components.

With a segment extracted, the neurosymbolic synthesizer 118 or LLM 112 is employed again to synthesize a new subprogram. The subprogram synthesis process integrates feedback from validation and adjusts the original specification dynamically to ensure targeted refinement. The subprogram is synthesized and conditioned on this updated specification and the reusable segment.

Next, the program manager 114 combines the reusable segment and the new subprogram into a new candidate program using one or more program composition operations. Sequential composition is used to connect parsing (prefix) and formatting (suffix) in a linear workflow. If the task requires addressing input variability, conditional logic is introduced through if-then-else composition or conditional sequential composition, allowing the program to branch or adapt based on specific input properties. An example program can use sequential and conditional composition to ensure robust handling of varied inputs.

The solution iteratively refines the program through this process, while dynamically adjusting decomposition strategies and synthesis approaches. For example, if a Forward1 strategy fails to resolve all issues, the engine may shift to Backward1 or introduce IfThenElse logic. The system ensures each iteration progressively narrows errors while preserving correct components.

Finally, the program manager 114 reevaluates the new candidate program against the original specification. If the program satisfies the specification, the process concludes. If not, refinement continues until a predefined limit is reached or diminishing returns indicate further iterations are unlikely to yield improvements. This ensures efficiency while delivering a robust program capable of generalizing across diverse inputs.

The system's architecture ensures seamless collaboration between components, leveraging LLM capabilities, validation insights, and dynamic customization to iteratively refine programs. By decomposing, synthesizing, and recomposing program components, the system guarantees adherence to specifications while adapting to evolving requirements and input complexities.

By way of illustration, the technical solution begins with generating an original candidate program based on an original specification, which serves as the foundation for program synthesis. The original specification may consist of input-output examples, which explicitly define expected behaviors, or a high-level task description, which provides abstract guidance for the task. In some cases, the specification includes a combination of both, enabling the system to dynamically resolve ambiguities during candidate program synthesis. For example, if the task is to extract street names and postal codes from a list of addresses, the input-output examples might include addresses like “123 Main St, Springfield, IL 62704” mapped to “123 Main St, 62704”, and the task description might state, “Extract the street name and zip code, excluding the city name and other details.” A Large Language Model (LLM) is used to synthesize the initial program, generalizing these requirements into executable logic.

Once the original candidate program is generated, it is executed on the provided input-output examples or additional test cases to generate original candidate program results. The results are evaluated using validation metrics such as accuracy, precision, recall, and error rates to assess the program's performance. For instance, if the program processes an address but incorrectly includes the city name (e.g., “123 Main St, Springfield, 62704” instead of “123 Main St, 62704”), the system identifies the error and logs it for further analysis.

Validation involves analyzing variability in input formats to identify failure modes specific to certain inputs. For example, while the program might handle simple addresses correctly, it may fail with additional fields such as “Suite 200” or “Apt 3B”, highlighting its inability to manage variable-length input segments. Errors are then categorized into syntax errors (e.g., invalid code structure), logical errors (e.g., incorrect segment extraction), or structural errors (e.g., incorrect output formatting). This categorization allows the system to selectively target specific errors during refinement.

When the system determines that the original candidate program does not satisfy the original specification, it proceeds to decompose the program into smaller, reusable segments. This process identifies components such as prefixes (handling input parsing), suffixes (managing output formatting), or entire segments (e.g., a whole segment), depending on the program's structure. The decomposition strategy is dynamically selected based on the failure type:

Forward1 retains a correct prefix and refines the suffix when the input parsing logic is accurate.

Backward1 retains a correct suffix and refines the prefix when the output formatting logic is accurate.

IfThenElse introduces conditional logic to handle distinct cases, such as addresses with optional fields.

To further improve efficiency, the system evaluates the interchangeability of prefixes and suffixes to maximize their reusability.

Once a segment is extracted, the system uses the LLM to synthesize a new subprogram. The synthesis process involves combining the original specification with the extracted segment to create a refined subproblem. For example, if the extracted segment parses the address (parts=x.split(‘,’)), the new subprogram might focus on refining the suffix logic to accurately extract the postal code. Additionally, the system adjusts the specification dynamically based on validation feedback, ensuring the subprogram targets the identified failure modes. For instance, the refined specification might state, “Extract the last word of the final segment after removing leading and trailing spaces.”

The system then synthesizes a new candidate program by combining the extracted segment and the new subprogram using a program composition operation. The composition operation is selected based on the task and input complexity:

Sequential Composition: Combines parsing (prefix) and formatting (suffix) in a step-by-step manner.

If-Then-Else Composition: Introduces conditional branches to handle inputs with optional fields or irregular formatting.

Conditional Sequential Composition: Executes subprograms based on conditions derived from intermediate results.

For example, the refined program might process addresses with or without optional fields like “Suite 200” using:

```
Function extract_address(x):
  parts = x.split(‘,’)
  if “Suite” in x or “Apt” in x:
    filtered_parts = parts[:−2]
    zip_code = filtered_parts[−1].strip( ).split(“ ”)[−1]
  else:
    zip_code = parts[−1].strip( ).split(“ ”)[−1]
  return parts[0] + “, ” + zip_code
```

This program uses a combination of sequential and conditional composition to handle variable input structures, such as addresses with or without optional fields.

During synthesis, the system dynamically introduces logic for edge cases, such as filtering out optional fields, managing variable-length segments, or addressing irregular formatting. The iterative refinement process addresses validation failures at each step, adjusting the specification as needed and incorporating feedback into subsequent iterations. For example, the system might refine the subprogram to ensure it handles both “Suite 200” and “Apt 3B” without disrupting outputs for simpler inputs.

Finally, the system validates the new candidate program to ensure it satisfies the original specification. If the program meets all requirements, the process terminates. Otherwise, the system continues refinement by repeating the decomposition, synthesis, and composition steps until a robust and reliable solution is achieved. This iterative process ensures the final program generalizes effectively across diverse inputs, addressing edge cases and dynamically resolving task-specific ambiguities.

With reference to FIG. 2B, FIG. 2B a flow chart 200B associated with providing a compositional program synthesis using a compositional program synthesis engine in accordance with embodiments described herein. The technical solution of the compositional program synthesis engine can be explained by way of steps and an example composition program synthesis scenario.

At step 201B: Initial Program Generation—The process begins with an LLM synthesizing a candidate program based on the provided input-output examples or high-level specifications. This forms the starting point for subsequent refinements.

At step 202B: Program Validation—The generated program is executed on the provided examples to check if it satisfies the specification. If the program fails, the process identifies which parts of the program need refinement.

At step 203B: Program Decomposition—The incorrect program is analyzed and decomposed into smaller components (e.g., prefix, suffix, or the entire program). This decomposition is guided by the observation that parts of the program are often correct and can be salvaged for reuse. For example, prefixes typically handle input parsing, while suffixes handle output construction, and both are often accurate even in failed programs.

At step 204B: Strategy-Based Customization—The solution employs specific decomposition strategies based on the failure modes of the program: Forward1 Strategy: Focuses on retaining the correct prefix and resynthesizing the suffix; Backward1 Strategy: Retains the correct suffix and resynthesizes the prefix; and IfThenElse Strategy: Introduces conditional logic to combine partial solutions for different input cases.

At step 205B: Subprogram Synthesis—A new subprogram is synthesized by the LLM, conditioned on the correct components extracted in the decomposition phase and the original specification. This ensures the refinement process is targeted and efficient.

At step 206B: Program Composition—The salvaged components and newly synthesized subprograms are combined using standard composition operators such as: Sequential composition: Combines the output of one subprogram as the input to the next; and Conditional composition: Introduces branching logic to handle distinct cases in the input.

At step 207B: Validation, Iterative Refinement, and Termination—Once a program satisfies the specification, the process concludes. If no correct program is synthesized, the iterative process stops after a predefined limit, ensuring efficiency. The above steps are repeated iteratively. Each iteration produces a new candidate program by repairing errors in the previous program, systematically narrowing down to a solution that meets the specification.

By way of illustration, the task of extracting postal codes from address strings demonstrates the iterative process of program synthesis using an LLM enhanced by a structured recovery framework. A user provides input-output examples, such as mapping “123 Main St, Springfield, IL 62704” to “62704” and “456 Elm St, Shelbyville, KY 40065” to “40065”. An LLM first generates a candidate program based on these examples. For instance, the initial program might split the address string by commas and return the last segment, as in parts=address.split(“,”); return parts[−1].strip( ) However, this program fails to correctly isolate the postal code, erroneously including extraneous text like “IL 62704”.

To address this issue, the compositional program synthesis engine evaluates the generated program and identifies that part of the program, such as splitting the address by commas, is likely correct. This segment is extracted as a reusable prefix, while the remaining part of the program is marked for refinement. The compositional program synthesis engine then creates a new subproblem by combining the extracted segment with the original specification, isolating the suffix ([“IL 62704”, “KY 40065”]) and using the input-output examples to define a new specification for the desired transformation.

Based on this refined specification, the LLM synthesizes a new subprogram to clean the suffix and extract the postal code, such as return part.strip( )split (“ ”)[−1]. The compositional program synthesis engine then recomposes the extracted prefix and the newly generated subprogram using sequential composition, resulting in an updated program: parts=address.split(“,”); return clean_postal_code(parts [−1]). The combined program is validated against the original input-output examples. If it still fails, further iterations are triggered, repeating the process of extracting, refining, and recombining until the program fully satisfies the specification.

This iterative method adapts seamlessly to programming-by-example (PBE) contexts by dynamically generating input-output specifications for subtasks. Through systematic decomposition and targeted subprogram synthesis, the approach increases the likelihood of generating a correct program. Unlike methods such as self-reflection, which reattempt the entire task in each iteration, this structured recovery framework focuses on solving smaller, simpler subproblems, leveraging both symbolic reasoning and LLM capabilities to achieve success.

Aspects of the technical solution have been described by way of examples and with reference to FIGS. 1A, 1B, 1C, 2A and 2B. FIG. 2A is a block diagram of an exemplary technical solution environment, based on example environments described with reference to FIGS. 6, 7 and 8 for use in implementing embodiments of the technical solution are shown. Generally the technical solution environment includes a technical solution system suitable for providing the example cloud computing system 100 in which methods of the present disclosure may be employed. In particular, FIG. 2A illustrates a high-level architecture of the cloud computing system 100 in accordance with implementations of the present disclosure, among other engines, managers, generators, selectors, or components not shown (collectively referred to herein as “components”).

### Example Methods

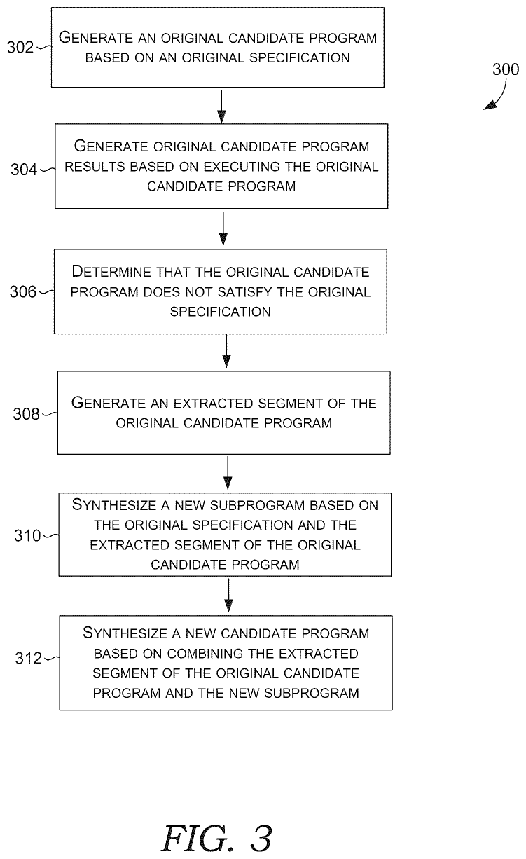

With reference to FIGS. 3, 4, and 5, flow diagrams are provided illustrating methods for providing compositional program synthesis using a compositional program synthesis engine in an artificial intelligence system. The methods may be performed using the artificial intelligence system described herein. In embodiments, one or more computer-storage media having computer-executable or computer-useable instructions embodied thereon that, when executed, by one or more processors can cause the one or more processors to perform the methods (e.g., computer-implemented method) in the artificial intelligence system (e.g., a computerized system).

Turning to FIG. 3, a flow diagram is provided that illustrates a method 300 for providing compositional program synthesis using a compositional program synthesis engine in an artificial intelligence system. At block 302, generate an original candidate program based on an original specification. At block 304, generate original candidate program results based one executing the original candidate program. At block 306, determine that the original candidate program does not satisfy the original specification. At block 308, generate an extracted segment of the original candidate program. At block 310, synthesize a new subprogram based on the original specification and the extracted segment of the original candidate program. At block 312, synthesize a new candidate program based on combining the extracted segment of the original candidate program and the new subprogram.

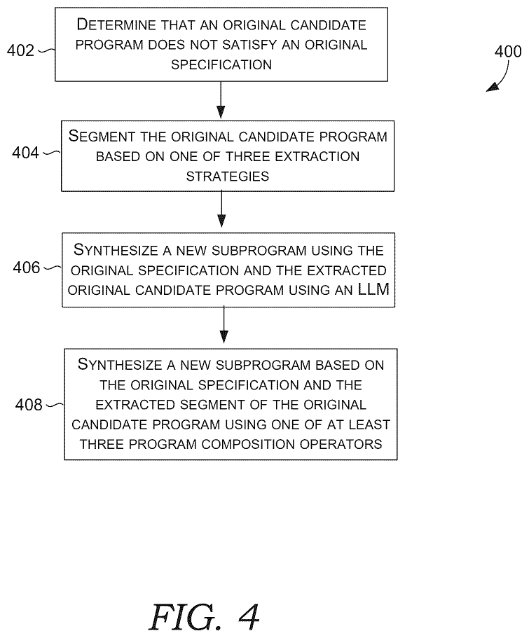

Turning to FIG. 4, a flow diagram is provided that illustrates a method 400 for providing compositional program synthesis using a compositional program synthesis engine in an artificial intelligence system. At block 402, determine that an original candidate program does not satisfy an original specification. At block 402, segment the original candidate program based on one of three extraction strategies. At block 404, synthesize a new subprogram using the original specification and the extracted original candidate program using an LLM. At block 406, synthesize a new subprogram using the original specification and the extracted original candidate program using an LLM. At block 408, synthesize a new subprogram based on the original specification and the extracted segment of the original program using one of at least three program composition operators.

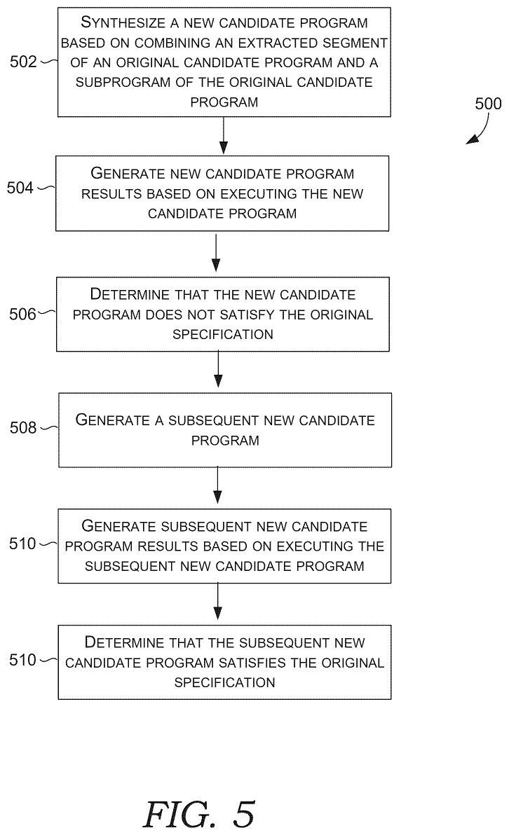

Turning to FIG. 5, a flow diagram is provided that illustrates a method 500 for providing compositional program synthesis using a compositional program synthesis engine in an artificial intelligence system. At block 502, synthesize a new candidate program based on combining an extracted segment of an original candidate program and a subprogram of the original candidate program. At block 504, generate new candidate program results based on executing the new candidate program. At block 506, determine that the new candidate program does not satisfy the original specification. At block 508, generate a subsequent new candidate program. At block 510, generate subsequent new candidate program results based on executing the subsequent new candidate program. At block 512, determine that the subsequent new candidate program satisfies the original specification.

### TECHNICAL IMPROVEMENT

Embodiments of the present techniques have been described with reference to several inventive features (e.g., operations, systems, engines, and components) associated with an artificial intelligence system. Inventive features described include: operations, interfaces, data structures, and arrangements of computing resources associated with providing the functionality described herein relative with reference to a compositional program synthesis engine 110. Functionality of the embodiments of the present invention have further been described, by way of an implementation and anecdotal examples—to demonstrate that the operations for providing the compositional program synthesis engine 110 as a solution to a specific problem in artificial systems technology to improve computing operations in artificial intelligence systems.

The compositional program synthesis engine represents a significant technical improvement by introducing a structured, modular approach to generating and refining programs. The compositional program synthesis engine combines the capabilities of neural models, such as large language models (LLMs), with symbolic techniques, creating a hybrid system that balances flexibility and precision. Unlike traditional methods that generate programs in a single pass, this compositional program synthesis engine systematically breaks down the synthesis process into manageable stages, enabling targeted corrections and ensuring that the final program adheres to the user's specifications.

Compositional program synthesis engine decomposes failed programs into reusable segments, such as prefixes, suffixes, or even the entire program. By identifying and retaining correct components, the compositional program synthesis engine avoids redundant effort, focusing instead on refining only the erroneous portions. This decomposition is guided by dynamic strategies, such as Forward1 (refining suffixes), Backward1 (refining prefixes), or IfThenElse (introducing conditional logic), which are selected based on the type of failure identified during validation. These strategies allow the compositional program synthesis engine to adapt to diverse failure modes and input complexities, making it robust in handling a wide range of programmatic tasks.

Compositional program synthesis engine supports an iterative refinement process, which ensures continuous improvement of the program through validation and feedback loops. After each iteration, the system evaluates the program using validation metrics to measure its performance against the original specification. If the program fails to meet the specification, the compositional program synthesis engine analyzes the errors, categorizing them into syntax errors, logical errors, or structural errors. This categorization enables selective targeting of issues, ensuring that each refinement cycle addresses the most critical problems.

The synthesis of subprograms is another defining feature. Leveraging the LLM, the compositional program synthesis engine generates new subprograms that are conditioned on both the original specification and the reusable segments extracted from the failed program. This step is not limited to neural methods; the integration of symbolic synthesis allows for precise handling of well-defined tasks, ensuring that subprograms are both accurate and reliable. Additionally, the compositional program synthesis engine dynamically adjusts the specification for subprogram synthesis based on intermediate results, making the process highly responsive to specific task requirements and validation feedback.

Compositional program synthesis engine's program composition operations further enhance its flexibility and scalability. It supports various forms of composition, including sequential composition, where the output of one subprogram becomes the input to another; if-then-else composition, which introduces branching logic for distinct cases; and conditional sequential composition, which enables subprogram execution based on intermediate states. These operations allow the engine to handle complex tasks with nested logic, variable-length inputs, or edge cases that require specialized handling, such as optional fields or irregular formatting.

Overall, the compositional program synthesis engine introduces a transformative approach to program synthesis by integrating dynamic decomposition, iterative refinement, advanced validation, and flexible program composition. These features collectively address the limitations of traditional neural or symbolic methods, enabling the generation of robust, adaptable, and reliable programs for complex, real-world tasks. This compositional program synthesis engine not only enhances the accuracy of program synthesis.

### Additional Support for Detailed Description

### Example Artificial Intelligence (AI) System in a Computing Environment

Referring now to FIG. 6, FIG. 6 illustrates a computing environment in which implementations of the present disclosure may be employed. In particular, FIG. 6 shows a high level architecture of an example cloud computing platform 600, artificial intelligence (AI) system 600A, and computing system 610 that can host a technical solution environment. It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The cloud computing platform 600 provides computing system resources for different types of managed computing environments. For example, the cloud computing platform supports delivery of computing services-including compute, servers, storage, databases, networking, and intelligence. The components of cloud computing platform 600 may communicate with each other over a network 600B which may include, without limitation, one or more local area networks (LANs) and/or wide area networks (WANs).

The AI system 600A provides a specialized infrastructure designed to support the computational demands of artificial intelligence (AI) workloads, including both training and inference tasks. The AI backend network systems 600A consists of interconnected components that facilitate the efficient processing, communication, and management of data within a distributed computing environment. Operations include data processing, handling input data, intermediate results, and output data, alongside complex computations for AI tasks, communication facilitating seamless interaction among components, and resource management overseeing optimal utilization of compute nodes, accelerators (e.g., GPUs, TPUs), memory, and storage. Interfaces encompass network interfaces enabling high-speed communication between nodes, APIs providing standardized interaction methods for developers, and management interfaces for system monitoring and administration. Data support functionalities include storage, data movement, transformation, and replication with backup mechanisms, ensuring data durability and reliability. In this way, the AI backend network system serves as the backbone infrastructure for AI workloads, facilitating efficient and scalable AI processing across distributed computing environments through its comprehensive operations, interfaces, and data management functionalities.

The cloud computing platform 600 provides the foundational infrastructure and resources for deploying and managing computing workloads, including AI. AI system 600A includes specialized infrastructures tailored for supporting the unique computational demands of AI workloads. The relationship between the two involves resource provisioning, integration, orchestration, and data processing, enabling organizations to leverage cloud-based resources effectively for AI development and deployment.

The computing system 610 provides computing functionality for computing environments. For example, the computing system 610 is a platform or framework that leverages advanced technologies such as artificial intelligence (AI), machine learning (ML), data mining, and big data analytics to extract actionable insights and knowledge from large and complex datasets. In this way, the computing system 610 provides a computing environment that enables organizations to make informed decisions and optimize operations.

The computing system 610 includes a computing engine 620 that is a computing environment that supports executing computational tasks associated with the computing system 610. The computing engine 620 can be a hardware or software component that performs computational operations, such as, mathematical calculations, data processing, and algorithm execution. The computing system 610 integrates computing resources 630 into computing system 610 to effectively provide computing functionality in a computing environment.

The computing resources 630 refer to computing elements (e.g., components, capability, or entities) that collectively enable the computing engine 620 operations. The computing resources 630 encompass a spectrum of computing elements, beginning with the diverse operations the computing resources 630 can perform, ranging from complex computations to data manipulations. Interfaces, an integral part of the computing resources 630, provide the means for both user interaction and seamless integration with external systems, ensuring a dynamic and interactive computing experience. The data facet of the data computing resources 630 involves various types: input data, which is the information provided for processing; processing data, representing the data manipulated during computational tasks; and output data, the results generated by the computing engine 620. In this way, the computing resources 630 support the broader computing engine 620 and computing system 610.

Machine learning engine 640 is a machine learning framework or library that operates as a tool for providing infrastructure, algorithms, capabilities for designing, training, and deploying machine learning models. The machine learning engine 640 can include pre-built functions and APIs that enable building and applying machine learning techniques. The machine learning engine 640 can provide a machine learning workflow from data processing and feature extraction to model training, evaluation, and deployment.

Machine learning data 642 refers to the structured or unstructured information used to train, validate, and test machine learning models. This machine learning data 642 typically comprises input features (also known as independent variables or predictors) and their corresponding target values (also known as dependent variables or labels). Machine learning data 642 can come from various sources, such as databases, sensor readings, text documents, images, audio recordings, or streaming data sources. Machine learning data 642 may require preprocessing, cleaning, and transformation to ensure its suitability for training machine learning models. Additionally, machine learning data 642 is often divided into training, validation, and testing sets to assess the performance and generalization ability of trained models accurately.

Machine learning models 644 are algorithms or mathematical representations that learn patterns and relationships from the provided data to make predictions or decisions without being explicitly programmed. Machine learning models 644 models are trained using the machine learning data 642, where they iteratively adjust their internal parameters or coefficients to minimize prediction errors or maximize performance metrics. Machine learning models 644 can be classified into various types based on their learning algorithms and the nature of the problem they address, including supervised learning models (e.g., regression, classification), unsupervised learning models (e.g., clustering, dimensionality reduction), and reinforcement learning models. Once trained, machine learning models 644 can be deployed in production environments to make predictions on new, unseen data instances. Regular evaluation and monitoring of model performance are essential to ensure their accuracy, reliability, and effectiveness in real-world applications.

The computing client 650 supports access to computing system 610. The computing client 650 can be provided as a user client or an administrator client to support user and administrator functionality associated with the computing environment 660, computing engine 620, or computing system 610. The computing client 650 can also support accessing computing visualizations and causing display of the computing visualization. The computing client 650 can include a computing engine client that supports receiving computing information associated computing engine 620 output from the computing system 610 and causing presentation of the computing information. The computing information can specifically include computing visualizations associated with the computing engine 620 output.

Computing environment 660 is a computing environment that is integrated into the computing system 610. The computing environment 660 is characterized by an infrastructure, where data from various sources within the ecosystem, including servers, networks, applications, sensors, and user interactions, can be aggregated and processed by the computing system 610 to perform computing tasks. The computing environment 660 can be associated with middleware and integration layers facilitate seamless data flow, while computing infrastructure, encompassing cloud-based resources, distributed computing frameworks, and optimized storage systems, supports functionality associated with the computing.

### Example Distributed Computing System Environment

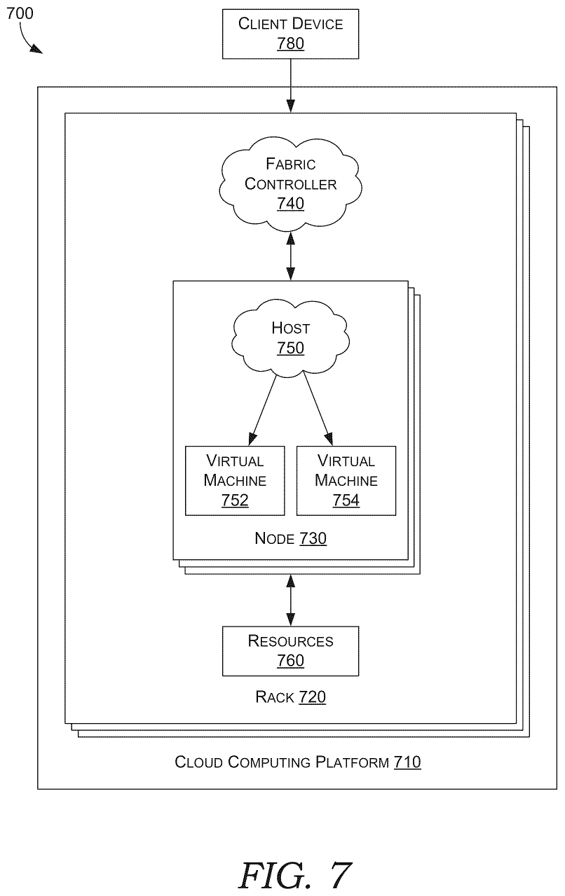

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing platform 710 in a data center can be configured to host and support operation of endpoints of a particular service application. Cloud computing platform 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 800 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

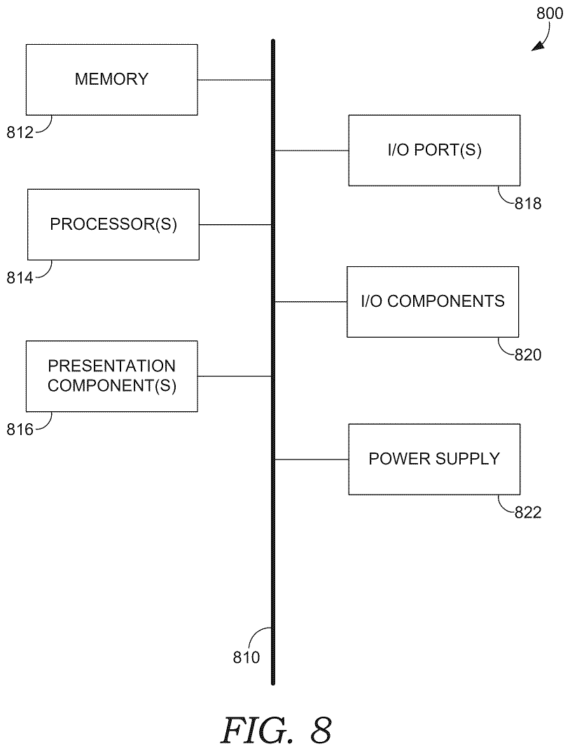

Having briefly described an overview of embodiments of the present technical solution, an example operating environment in which embodiments of the present technical solution may be implemented is described below in order to provide a general context for various aspects of the present technical solution. Referring initially to FIG. 8 in particular, an example operating environment for implementing embodiments of the present technical solution is shown and designated generally as computing device 800. Computing device 800 is but one example of a suitable computing environment and is not intended to suggest any limitation as to the scope of use or functionality of the technical solution. Neither should computing device 800 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### Additional Structural and Functional Features

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

For purposes of this disclosure the word “support” refers to provisioning of functionality, services, or assistance by a computing component or through computing operations within a broader computing system. When a computing component or set of operations supports a specific functionality, it means that it plays a role in enabling or executing that particular aspect of the computing system. This support can manifest in various ways, including the processing of data, execution of operations, management of resources, and ensuring compatibility or interoperability with other components. Additionally, support may involve providing interfaces, APIs (Application Programming Interfaces), or protocols that allow seamless interaction and integration with other elements of the computing system. The concept of support extends beyond mere functionality provision to encompass maintenance, troubleshooting, and the overall optimization of computing resources to ensure the robust and efficient operation of the computing system.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors;
computer memory storing computer-useable instructions that, when used by the one or more computer processors, cause the one or more computer processors to perform operations, the operations comprising:
generating an original candidate program based on an original specification;
generating original candidate program results based on executing the original candidate program;
based on the original candidate program results, determining that the original candidate program does not satisfy the original specification;
based on determining that the original candidate program does not satisfy the original specification, generating an extracted segment of the original candidate program;
using a Large Language Model (LLM), synthesizing a new subprogram based on the original specification and the extracted segment of the original candidate program; and
using the LLM, synthesizing a new candidate program based on combining the extracted segment of the original candidate program and the new subprogram with a program composition operation.

2. The system of claim 1, wherein the original specification comprises input-output examples or a high-level task description.

3. The system of claim 1, wherein determining that the original candidate program does not satisfy the original specification further comprises analyzing variability in input formats and identifying failure modes based on input-specific characteristics.

4. The system of claim 1, wherein generating the extracted segment of the original candidate program further comprises dynamically selecting a decomposition strategy, based on a type of failure identified, including a first decomposition strategy associated with refining suffixes, a second decomposition strategy associated with refining prefixes, and a third decomposition strategy associated with IfThenElse associated with distinct input cases.

5. The system of claim 1, wherein generating the extracted segment of the original candidate program is based on:
extracting a prefix segment of the original candidate program;
extracting a suffix segment of the original candidate program; or
extracting a whole segment of the original candidate program.

6. The system of claim 1, wherein synthesizing the new subprogram is based on:
using a selected program composition operation, generating a new specification for the new subprogram based on combining the original specification comprising a high-level task description or input-output examples using and the extracted segment of the original candidate program; and
using the LLM, synthesizing the new subprogram based on the new specification.

7. The system of claim 1, wherein synthesizing the new subprogram further comprises adjusting the original specification dynamically based on partial outputs and validation results from the original candidate program.

8. The system of claim 1, wherein the program composition operation associated with synthesizing the new candidate program is selected from one of: a sequential composition; an If-then-else composition; and a conditional sequential composition.

9. The system of claim 1, wherein synthesizing the new candidate program further comprises combining multiple program composition operations, including sequential composition and conditional composition, in a single candidate program.

10. The system of claim 1, the original candidate program is associated with a compositional program synthesis engine that supports iteratively repeating compositional program synthesis operations until candidate program results of an iteration of a candidate program satisfies the original specification.

11. One or more computer-storage media having computer-executable instructions embodied thereon that, when executed by a computing system having a processor and memory, cause the processor to perform operations, the operations comprising:
generating an original candidate program based on an original specification;
generating original candidate program results based on executing the original candidate program;
based on the original candidate program results, determining that the original candidate program does not satisfy the original specification;
based on determining that the original candidate program does not satisfy the original specification, generating an extracted segment of the original candidate program;
using a Large Language Model (LLM), synthesizing a new subprogram based on the original specification and the extracted segment of the original candidate program; and
using the LLM, synthesizing a new candidate program based on combining the extracted segment of the original candidate program and the new subprogram with a program composition operation.

12. The media of claim 11, wherein generating the extracted segment of the original candidate program further comprises dynamically selecting a decomposition strategy, based on a type of failure identified, including a first decomposition strategy associated with refining suffixes, a second decomposition strategy associated with refining prefixes, and a third decomposition strategy associated with IfThenElse associated with distinct input cases.

13. The media of claim 11, wherein generating the extracted segment of the original candidate program comprises one of:
extracting a prefix segment of the original candidate program;
extracting a suffix segment of the original candidate program; and
extracting a whole segment of the original candidate program.

14. The media of claim 11, wherein synthesizing the new subprogram is based on:
using a selected program composition operation, generating a new specification for the new subprogram based on combining the original specification comprising a high-level task description and the extracted segment of the original candidate program; and
using the LLM, synthesizing the new subprogram based on the new specification.

15. The media of claim 11, wherein the program composition operation associated with synthesizing the new candidate program is selected from one of: a sequential composition; an If-then-else composition; and a conditional sequential composition.

16. A computer-implemented method, the method comprising:
generating an original candidate program based on an original specification;
generating original candidate program results based on executing the original candidate program;
based on the original candidate program results, determining that the original candidate program does not satisfy the original specification;
based on determining that the original candidate program does not satisfy the original specification, generating an extracted segment of the original candidate program;
using a Large Language Model (LLM), synthesizing a new subprogram based on the original specification and the extracted segment of the original candidate program; and
using the LLM, synthesizing a new candidate program based on combining the extracted segment of the original candidate program and the new subprogram with a program composition operation.

17. The method of claim 16, wherein generating the extracted segment of the original candidate program further comprises dynamically selecting a decomposition strategy, based on a type of failure identified, including a first decomposition strategy associated with refining suffixes, a second decomposition strategy associated with refining prefixes, and a third decomposition strategy associated with IfThenElse associated with distinct input cases.

18. The method of claim 16, wherein generating the extracted segment of the original candidate program comprises one of:
extracting a prefix segment of the original candidate program;
extracting a suffix segment of the original candidate program; and
extracting a whole segment of the original candidate program.

19. The method of claim 16, wherein synthesizing the new subprogram is based on:
using a selected program composition operation, generating a new specification for the new subprogram based on combining the original specification comprising a high-level task description and the extracted segment of the original candidate program; and
using the LLM, synthesizing the new subprogram based on the new specification.

20. The method of claim 16, the method further comprising:
generating new candidate program results based on executing the new candidate program;
based on the new candidate program results, determining that the new candidate program does not satisfy the original specification;
generating a subsequent new candidate program;
generating subsequent new candidate program results based on executing the subsequent new candidate program; and
based on the subsequent new candidate program results, determining that the subsequent new candidate program satisfies the original specification.
